(19) United States
(12) Patent Application Publication
(10) Pub. No.: US 2004/0007376 A1
(43) Pub. Date: Jan. 15, 2004

(54) Integrated thermal vias

(76) Inventors: Eric Urdahl, Eau Claire, WI (US); Bruce Lee, Chippewa Falls, WI (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/193,570

(22) Filed: Jul. 9, 2002

(51) Int. Cl. H02G 3/08

(52) U.S. Cl. 174/52.1

(57) ABSTRACT

Improved thermal conductivity in printed wiring boards can be achieved without resorting to the use of dedicated thermally conductive components such as thermal vias and heat sinks. Instead, electrically functional vias, through holes, pads, and traces are modified to improve their thermal conductivity. Such modifications include thickly plating the walls of through holes or vias, possibly to the point where the via or through hole is completely filled, and also include de-planarazing the surfaces of pads and traces.

### FIELD OF THE INVENTION

The field of the invention is printed electrical interconnect thermal dissipation.

### BACKGROUND OF THE INVENTION

Electrical interconnects are known electronic component structures such as printed wiring boards which contain copper strips or paths arranged in a conductive pattern on a relatively flat electrically insulative structure or base. The copper strips form current-conducting paths (the electric wiring) by means of which other electrical components thereafter mounted on the interconnect may receive or pass electrical current to other electrical components, similarly mounted, or from a power source.

In many instances, the components mounted to an interconnect require high heat dissipation during operation. This is especially true in circuit arrangements including power components such as power modules for controlling and driving other assemblies or the like. In order to adequately remove the heat generated by the power dissipation of the components one known solution relates to improving the vertical heat transfer through the supporting interconnect. This is achieved by providing thermal through-contacts, i.e. so-called thermal vias, extending through the supporting substrate from the top surface to the bottom surface thereof. Examples applications of thermal vias can be found in U.S. Pat. Nos. 5,814,883, 5,959,356, 5,990,550, 6,175,497, and 6,190,941, each of which is herein incorporated by reference in its entirety.

To form such thermal vias, it is typical to form one or more through-holes through the substrate directly beneath the rear contact or mounting surfaces of the respective components, and then metallizing the sides/inner surfaces of the through-holes, for example with a copper coating, through the entire thickness of the interconnect and covering the entire inner surfaces of the through-holes. In some instances, such as in U.S. Pat. No. 5,814,883, the vias have plated walls with an epoxy filled core. Once formed, thermal vias are typically coupled to a heat-sink or other thermally conductive layer. As such heat-sinks and thermally conductive layers are generally both electrically and thermally conductive, it is important that the thermal vias be electrically insulated from any functional electrically conductive signal paths in order to prevent undesired shorting of such paths.

Unfortunately, known methods for formation of thermal vias tend to result in wasted space and thermal via structures having inadequate thermal dissipation characteristics. Thus, there is a continuing need for new thermal via structures and methods for producing them.

### SUMMARY OF THE INVENTION

The present invention is directed to methods and devices providing for improved thermal conductivity in printed wiring boards (PWBs) and other electrical interconnects (hereinafter “interconnects”) through the use of electrically functional but non-planar pads and/or traces, and the use of conductive vias having a wall plating thickness of at least 0.002 inches, and possibly being fully filled with a plated material. For the sake of clarity and simplicity, the terms PWB and “printed wiring board” will be used in place of “electrical interconnect”.

As used herein, the term “pads” generally refers to surface mount pads and through hole via pads. Surface mount pads are generally conductive areas formed on a planar surface of a dielectric substrate that are sized and dimensioned to facilitate the formation of an electrical connection between a PWB and another device such as a surface mounted integrated circuit or a test probe. Through hole via pads are generally conductive areas formed on a planar surface of a dielectric substrate that are sized and dimensioned to facilitate an electrical connection to a through hole of the PWB.

As used herein, “traces” refers to electrical conductors sized and dimensioned to route electricity between components of the PWB so as to coupled such components together to form electrical circuits.

As used herein, “electrically functional” indicates that the via, through hole, pad, trace, or other component in question is electrically conductive and either an integral part of the circuit embodied in the interconnect, or provides an access point for measuring characteristics of integral parts of the circuit embodied in the interconnect. Stated alternatively, an electrically functional component is an electrically conductive component that serves a purpose related to its electrical conductivity that is something other than to dissipate heat.

In many instances, the pads and/or traces will be relatively planar when first formed and subsequently de-planarized by etching, lasing, drilling, or other process to form a non-planar pattern in one or more surfaces of the pads and/or traces. As used herein, de-planarized indicates that a surface was processed in some fashion in order to increase its surface area, typically by modifing it to include a plurality of grooves and/or indentations. In some instances, de-planarization will comprise drilling holes in pads and/or traces. In other instances, de-planarization will comprise etching grooves.

It should be noted that the surface being de-planarized (modified to increase its surface area) will not be truly planar prior to processing. As an example, a copper clad laminate may be subjected to etching in order to form pads and traces, and may also be subjected to a build-up process such as plating in order to achieve a desired thickness in the pads and traces. Although microscopic examination of the surfaces of any such pads or traces would likely reveal surface variations resulting from the methods used to form them, such variations are not sufficiently great for such pads or traces to be classified as non-planar as the term is used herein. Instead, it is contemplated that such a “planar” surface will subsequently be subjected to additional processing in order to make it less planar (i.e. to de-planarize it).

De-planarizing existing components such as pads and traces will improve their thermal dissipation capabilities and the thermal dissipation characteristics of an interconnect without incurring the cost in space associated with the use of dedicated thermal vias and heat-sinks.

Increasing the plating thickness in conductive vias beyond the thickness required for electrical conductivity increases the thermal conductivity of the vias without using any additional space.

Plating conductive vias until they are fully filled with plated material may provide the maximum thermal conductivity possible for such vias. Moreover, fully plating the vias will eliminate any need to fill the vias after plating.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a cross-section side view of an interconnect according to the claimed invention.

FIG. 2A is a perspective view of a de-planarized pad according to the claimed invention.

FIG. 2B is a side view of the pad of FIG. 2 according to the claimed invention.

FIG. 3 is a perspective view of a second de-planarized pad according to the claimed invention.

### DETAILED DESCRIPTION

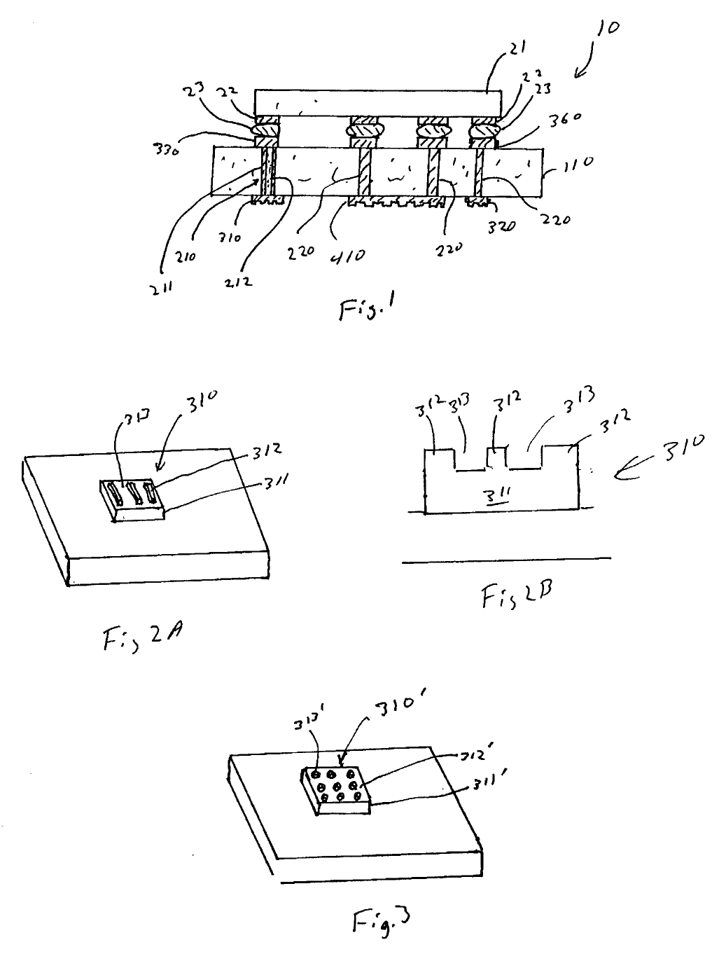

In the embodiment of FIG. 1, an interconnect 10 comprising a substrate 110, a plated and filled via 210, fully plated vias 220, de-planarized pads 310 320, and 360, standard pads 330, 340, and 350, and de-planarized trace 410. Substrate 110 may comprise a single dielectric layer, or multiple dielectric and/or conductive layers. Vias, whether thickly plated or fully plated may be either through holes as shown, or blind vias that do not pass all the way through substrate 110. The vias shown are formed by plating vias and through holes beyond what is required simply for electrical conductivity, and the pads and traces are first formed in a standard manner, and then de-planarized through the use of a laser or chemical etching process, or some other process. Although copper is considered particularly suitable for use in plating the vias and forming the pads and traces, any material which is both thermally and electrically conductive may be used instead.

Referring to FIGS. 2A and 2B, de-planarized pad 310 comprises base 311, ridges 312, and grooves 313. Ridges 312 have a width W1 and grooves 313 have a width W2. Base 311 has a height H1 and grooves 313 have a height H2.

Referring to FIGS. 3, de-planarized pad 310′ comprises base 311′, non-linear ridges 312′, and holes 313′. Holes 313′ are preferably formed by drilling. It is currently preferred that the holes 313′ take up 30% to 80% of the surface area of pad 310′.

It should be noted that the pattern of ridges and grooves shown will likely vary between embodiments. As the pads and traces are effectively miniature heat-sinks, the actual choice of pattern will be determined in a manner similar to the choice of pattern for a heat sink, except that the significantly smaller size of the pads and traces and the need for keeping them electrically isolated from each other will also need to be considered. As an example, a particular embodiment may utilize non-rectangular and/or non-parallel grooves, and a particular embodiment may comprise a plurality of ridges that are not all the same height, or a plurality of grooves that are not all the same depth.

Despite the variety of possible patterns, it is currently preferred that H2 be at least 0.001 inches, or at least 50% of H1, and that W1 be 0.002 inches, and that W2 be 0.002 inches.

De-planarization may be accomplished by any process that achieves the desired pattern. As such build-up processes such as plating may be used as well as material removal processes such as etching, and drilling. However, it is currently preferred that the pattern be formed by laser ablation or chemical etching. It is contemplated that in some embodiments it may be desirable to de-planarize one or more sides of a pad or trace in addition to the surface opposite the dielectric layer to which it is coupled.

Referring back to FIG. 1, through hole 210 can be seen to comprise plated walls 211 and fill material 212. It is contemplated that plating walls to a thickness greater than or equal to 0.002 inches is necessary to achieve a desirable increase in thermal conductivity. It is also contemplated that fully filled vias 220 will have an optimum thermal conductivity. It is currently preferred that electroplating be used to fill the vias, but any process which achieves the desired thickness or degree of filling would be suitable for use.

One method of forming interconnect 10 of FIG. 1 comprises: (a) providing a copper clad laminate; (b) drillingthrough-hole vias in the laminate; (c) plating the through holes to achieve plating thickness of at least 0.002″; (d) etching the copper cladding to form a desired patter of pads and traces; (c) plating the pattern to achieve a desired pad and trace thickness; (d) subjecting the pads and/or traces to subsequent processing so as to make the pads and/or traces less planar.

Thus, specific embodiments and applications of the claimed invention have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An interconnect comprising at least one electrically functional non-planar pad or trace.

2. The interconnect of claim 1 wherein the non-planar pad or trace is a de-planarized pad or trace.

3. The interconnect of claim 2 wherein the de-planarized pad or trace comprises at least two de-planarized surfaces, the de-planarized surfaces being perpendicular to each other.

4. The interconnect of claim 2 wherein the de-planarized pad or trace has been formed into a plurality of parallel ridges or round holes with adjacent ridges being separated by grooves.

5. The interconnect of claim 4 wherein the height of the ridges is at least 50% of the overall height, and the width of the ridges is 0.002 inches.

6. An interconnect comprising at least one blind via or through hole having a wall coated with plated material, the plated material being at least 0.002 inches thick.

7. The interconnect of claim 6 wherein the at least one via or through hole is fully filled with plated material.

8. A method of forming an interconnect comprising:
providing a copper clad laminate comprising a conductive pattern having at least one pad or trace;
subjecting the at least one pad or trace to subsequent processing so as to make it less planar.

9. The method of claim 8 wherein the subsequent processing comprises etching grooves into the at least one pad or trace.

10. The method of claim 8 wherein the subsequent processing comprises plating ridges onto the at least one pad or trace.

11. The method of claim 8 wherein the subsequent processing comprises drilling holes in the at least one pad or trace.

12. The method of claim 8 further comprising:
providing a copper clad laminate;
drillingthrough-hole vias in the laminate;
plating the through hole vias to achieve plating thickness of at least 0.002″;
etching the copper cladding to form a desired pattern of pads and traces;
plating the pattern to achieve a desired pad and trace thickness.
